(19) United States
(12) Patent Application Publication
(10) Pub. No.: US 2023/0221927 A1
(43) Pub. Date: Jul. 13, 2023

(54) K-CLUSTER RESIDUE NUMBER SYSTEM CAPABLE OF PERFORMING COMPLEMENT CONVERSION, SIGN DETECTION, MAGNITUDE COMPARISON AND DIVISION

(71) Applicant: Kneron Inc., San Diego, CA (US)

(72) Inventors: Oscar Ming Kin Law, San Diego, CA (US); Chun Chen Liu, San Diego, CA (US); Hsiang-Tsun Li, San Diego, CA (US); JUNJIE SU, San Diego, CA (US)

(73) Assignee: Kneron Inc., San Diego, CA (US)

(21) Appl. No.: 17/573,646

(22) Filed: Jan. 12, 2022

(51) Int. Cl. G06F 7/72

(52) U.S. Cl. CPC G06F 7/729

(57) ABSTRACT

A k-cluster residue number system includes a processor and a memory. The processor is used to generate a modular set composed of p coprime integers, generate a dynamic range by taking a product of the p coprime integers, generate row indices for all integers in the dynamic range, generate column indices for all integers in the dynamic range, and generate a look-up table according to the row indices, the column indices and all integers in the dynamic set. The memory is used to store the look-up table. The p coprime integers include 2.

### BACKGROUND OF THE INVENTION

### 1. Field of the Invention

The present invention is related to a k-cluster residue number system, and more particularly, to a memory-based k-cluster residue number system capable of performing complement conversion, sign detection, magnitude comparison and division.

### 2. Description of the Prior Art

Edge artificial intelligence (AI) computing is an area of rapid growth, which integrates neural networks with Internet of Things (IoT) together for computer vision, natural language processing, and self-driving car applications, it quantizes the floating-point number to fixed-point integer for inference operations. In-memory architecture is one of the important Edge AI computing platforms, which stacks the memory over the top of the logic circuits for Memory Centric Neural Computing (MCNC). The data is directly loaded from stacked memory to Processing Elements (PEs) for computation, it avoids loading the data from the external memory and minimizes data transfer. It significantly reduces the latency and speeds up the operations. The performance is further enhanced using Residue Number System (RNS), it fully utilizes the internal memory to store the data for integer operations.

Residue Number System (RNS) is a number system, which first defines the moduli set and transforms the numbers to their integer remainders (also called residue) through modulo division, then performs the arithmetic operations (addition and multiplication) on the remainders only. For examples, the moduli set is defined as (7, 8, 9) with the number 13 and 17. The dynamic range is defined by the product of moduli set with the range 504. It first transforms the numbers to its residue through the modulo operations 13→(6, 5, 4) and 17→(3, 1, 8), then performs addition and multiplication on residues only, (6, 5, 4)+(3, 1, 8)=(9, 6, 12)→(2, 6, 3), which is equal to 30. (6, 5, 4)*(3, 1, 8)=(18, 5, 32)→(4, 5, 5), which is equal to 221. Since the remainder magnitude is much smaller, it only requires the simple logic for parallel computations. The drawback of RNS is sign detection, magnitude comparison and division support. The residues are required to convert back to the binary number domain for those operations.

### SUMMARY OF THE INVENTION

In an embodiment, a method for generating a k-cluster residue number system comprises generating a modular set composed of p coprime integers, generating a dynamic range by taking a product of the p coprime integers, generating row indices for all integers in the dynamic range, and generating column indices for all integers in the dynamic range. The p coprime integers include 2.

In another embodiment, a k-cluster residue number system comprises a processor, and a memory coupled to the processor. The processor is used to generate a modular set composed of p coprime integers, generate a dynamic range by taking a product of the p coprime integers, generate row indices for all integers in the dynamic range, generate column indices for all integers in the dynamic range, and generate a look-up table according to the row indices, the column indices and all integers in the dynamic set. The memory is used to store the look-up table. The p coprime integers include 2.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a k-cluster residue number system according to an embodiment of the present invention.

FIG. 2 shows the look-up table in FIG. 1.

FIG. 3 shows the complement converter of the processor in FIG. 1.

FIG. 4 shows the sign detector of the processor in FIG. 1.

FIG. 5 is a method of determining the sign of an unknown integer according to an embodiment of the present invention.

FIG. 6 is a first method of magnitude comparison of two unknown integers according to an embodiment of the present invention.

FIG. 7 is a second method of magnitude comparison of two unknown integers according to an embodiment of the present invention.

FIG. 8 shows the division device of the processor in FIG. 1 when two unknown integers have the same sign.

FIG. 9 is a method for performing division of two unknown integers with the division device in FIG. 8.

FIG. 10 shows a division device of the processor in FIG. 1 when two unknown integers have the same sign according to another embodiment of the present invention.

FIG. 11 is a method for performing division of two unknown integers with the division device in FIG. 10.

FIG. 12 shows a division device of the processor in FIG. 1 when two unknown integers have different signs.

FIG. 13 is a method for performing division of two unknown integers with the division device in FIG. 12.

FIG. 14 shows a division device of the processor in FIG. 1 when two unknown integers have different signs according to another embodiment of the present invention.

FIG. 15 is a method for performing division of two unknown integers with the division device in FIG. 14.

### DETAILED DESCRIPTION

To represent an n-bit integer and its negative using a k-cluster residue number system (k-RNS), it first defines a modular set of p coprime integers as (m₁, . . . , 2, . . . , mₚ) where a dynamic range is generated according to the product of the modular set (m₁, . . . , 2, . . . , mₚ). When a modular set of 3 coprime integers is chosen to be (2^{n/2}−1, 2, 2^{n/2}+1), the dynamic range is set to [−(2ⁿ−1), (2ⁿ−2)]. The modular set is not limited to 3 coprime integers, the number of coprime integers in the modular set can be increased to increase the dynamic range and keep the moduli small. In this case, the k-RNS converts each integer in the dynamic range to its row indices and column index formed by remainders through modulo division such as Equation 1.

rᵢ=I mod mi Equation 1:

where:
rᵢ is a row index or a column index;
I is an integer in the dynamic range; and
mᵢ is a coprime integer of the modular set.

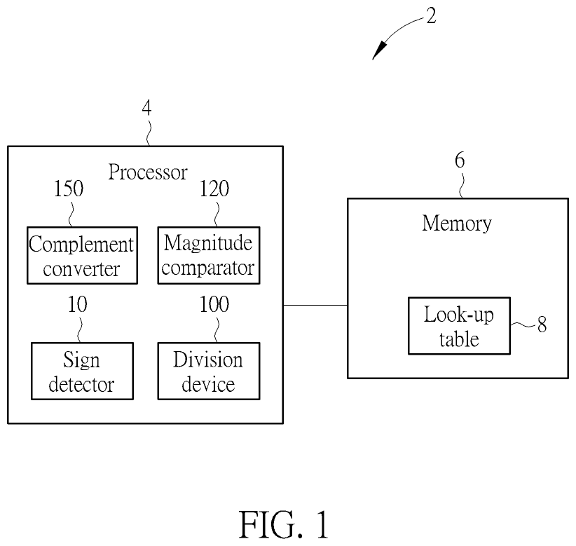

FIG. 1 shows a k-cluster residue number system (k-RNS) 2 according to an embodiment of the present invention. The k-cluster residue number system 2 may comprise a processor 4, and a memory 6 coupled to the processor 4. The processor 4 is used to generate the modular set composed of p coprime integers, generate the dynamic range by taking a product of the p coprime integers, generate row indices for all integers in the dynamic range, generate column indices for all integers in the dynamic range, and generate a look-up table 8 according to the row indices, the column indices and all integers in the dynamic set. One of the p coprime integers is 2. The memory 6 is used to store the look-up table 8. The processor 4 may comprise a complement converter 150, a sign detector 10, a division device 100 and a magnitude comparator 120.

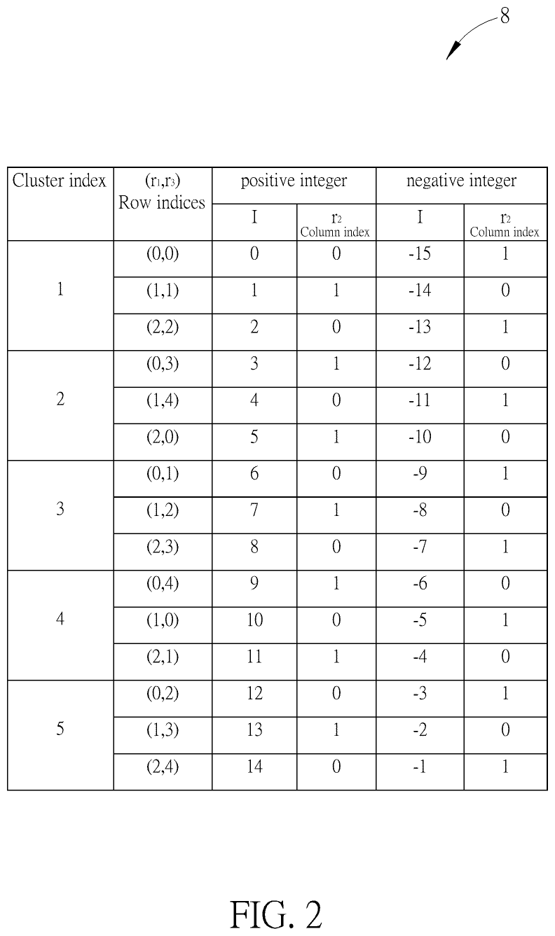

FIG. 2 shows the look-up table 8. The look-up table 8 can be exemplified by a 4-bit (n=4) integer. The modular set (m₁, m₂, m₃) of 3 integers can be chosen as (2^{n/2}−1, 2, 2^{n/2}+1)=(2^{4/2}−1, 2, 2^{4/2}+1)=(3,2,5) to represent the 4-bit integer and its negative. In this modular set, the first element m₁ and third element m₃ are moduli of row indices, and the second element m₂ is the modulus of the column index. The dynamic range is [−(2⁴−1),(2⁴−2)]=[−15,14]. That is, the dynamic range includes integers from −15 to 14. The modular set (3,2,5) is used throughout different embodiments of the detailed description for illustrative purposes, not for limiting the scope of the embodiments.

The look-up table 8 may include 4 columns: cluster index, row indices (r₁,r₃), positive integer column, and negative integer column. In this example, since the modular set has 3 coprime integers, each integer has 2 row indices and a column index. The positive integer column may list positive integers from 0 to 14 in an ascending order. The negative integer column may list negative integers from −15 to −1 in an ascending order. The integers are grouped according to the first row index modulo behavior. The integers 0 to 2, and −15 to −13 may be grouped to cluster 1. The integers 3 to 5, and −12 to −10 may be grouped to cluster 2. The integers 6 to 8, and −9 to −7 may be grouped to cluster 3. The integers 9 to 11, and −6 to −4 may be grouped to cluster 4. The integers 12 to 14, and −3 to −1 may be grouped to cluster 5. This grouping approach is only for an illustrative purpose, not for limiting the scope of the embodiment.

The k-RNS converts 0 to (0,0,0) through dividing (3,2,5), the coprime integers of the modular set, since (0,0,0) are remainders of 0 over (3,2,5); and converts −15 to (0,1,0) through dividing (3,2,5) since (0,1,0) are remainders of −15 over (3,2,5). The k-RNS converts 1 to (1,1,1) through dividing (3,2,5) since (1,1,1) are remainders of 1 over (3,2,5) and converts −14 to (1,0,1) through dividing (3,2,5) since (1,0,1) are remainders of −14 over (3,2,5). The k-RNS converts 2 to (2,0,2) through dividing (3,2,5) since (2,0,2) are remainders of 2 over (3,2,5) and converts −13 to (2,1,2) through dividing (3,2,5) since (2,1,2) are remainders of −13 over (3,2,5). The same approach can be applied to other numbers, and is thus not elaborated herein.

Because 0 and −15 have the same row numbers (0,0), 0 and −15 are listed in the same row. Their difference is that 0 has a column number of 0, and −15 has a column number of 1. Because 1 and −14 have the same row numbers (1,1), 1 and −14 are listed in the same row. Their difference is that 1 has a column number of 1, and −14 has a column number of 0. Because 2 and −13 have the same row numbers (2,2), 2 and −13 are listed in the same row. Their difference is that 2 has a column number of 0, and −13 has a column number of 1.

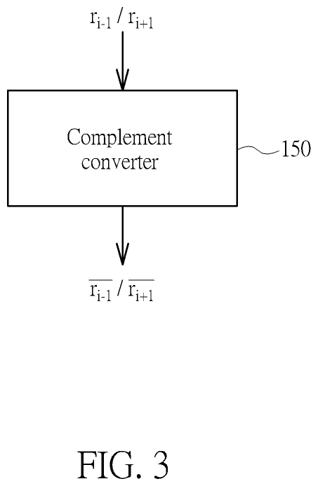

When an unknown integer is provided with row indices and a column index, the complement of the unknown integer can be determined. FIG. 3 shows the complement converter 150 of the processor 4. The complement converter 150 performs the sign conversion with moduli (m₁, m₃) being subtracted by their corresponding row indices (r₁, r₃) to generate (m₁−r₁, m₃−r₃) while keeping the column index r₂ intact. This approach is applied to all remainders except (0,1,0)→−15 because the complement of the negative integer −15 is outside the k-RNS dynamic range [−15,14] and can't be converted to any positive integer. For example, the complement converter 150 can convert the row indices (2,4) of the positive integer 14 to (3 −2,5 −4)=(1,1) while keeping the column index 0 intact. By checking the look-up table 8, it can be seen that the decimal representation of (1,0,1) is −14. Similarly, the row indices (1,1) of the negative integer −14 can be converted to (3 −1,0,5 −1)=(2,0,4) which is 14 in decimal representation. Thus the complement converter 150 can correctly perform sign conversion from positive integer to negative one and vice versa.

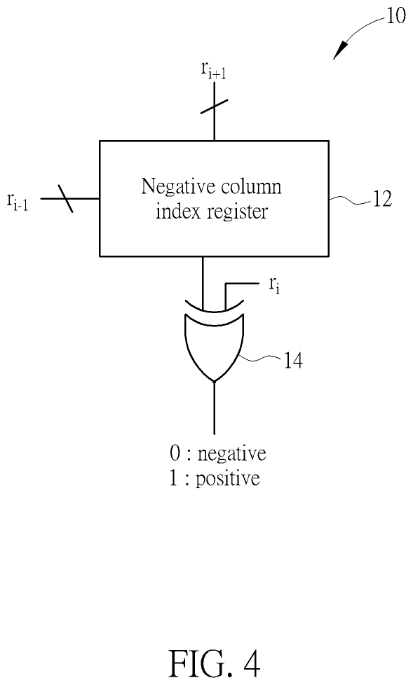

When an unknown integer is provided with row indices and a column index, the sign of the unknown integer can be determined. FIG. 4 shows the sign detector 10 of the processor 4. The sign detector 10 is used for determining the sign of the unknown integer. The sign detector 10 may comprise a negative column index register 12 and an XOR gate 14. The negative column index register 12 may have two inputs for receiving two row indices of the unknown integer, and an output. The negative column index register 12 stores a column index of each set of row indices when the set of row indices corresponds to a negative integer. The XOR gate 14 has a first input coupled to the output of the negative column index register 12 for receiving a column index of the unknown integer when the unknown integer is negative, a second input for receiving the column index of the unknown integer, and an output for indicating the sign of the unknown integer.

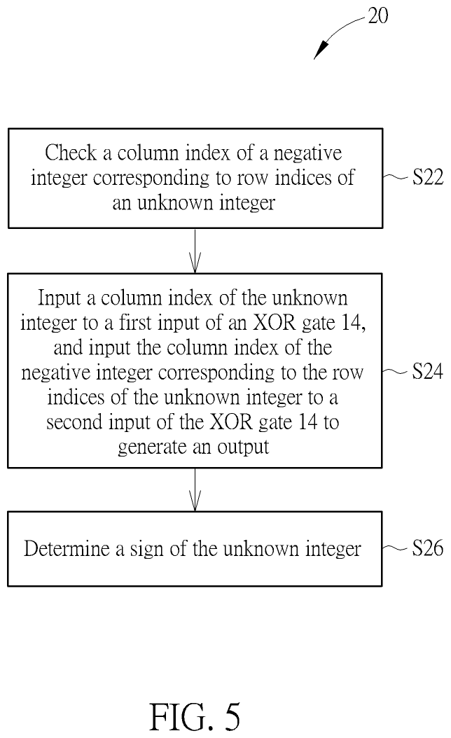

FIG. 5 is a method 20 of determining the sign of the unknown integer according to an embodiment of the present invention. The method 20 of determining the sign of the unknown integer comprises the following steps:

Step S22: check a column index of a negative integer corresponding to row indices of an unknown integer;

Step S24: input a column index of the unknown integer to a first input of an XOR gate 14, and input the column index of the negative integer corresponding to the row indices of the unknown integer to a second input of the XOR gate 14 to generate an output;

Step S26: determine a sign of the unknown integer according to the output. If the output is 0, the unknown integer is negative; if the output is 1, the unknown integer is positive.

The method of determining the sign of the unknown integer can be exemplified as follows: When an unknown integer has row indices of (0,0) and a column index of 0, the column index of the negative integer with the row indices of (0,0) is 1, 0 and 1 are input to the XOR gate 14, the XOR gate 14 will output 1. Since the output is 1, the unknown integer is positive. When referring to the look-up table 8, the unknown integer having row indices of (0,0) and a column index of 0 is 0, which is a positive integer. This agrees with the output of the XOR gate 14.

When an unknown integer has row indices of (0,0) and a column index of 1, the column index of the negative integer with the row indices of (0,0) is 1, 1 and 1 are input to the XOR gate 14, the XOR gate 14 will output 0. Since the output is 0, the unknown integer is negative. When referring to the look-up table 8, the unknown integer having row indices of (0,0) and a column index of 1 is −15, which is a negative integer. This agrees with the output of the XOR gate 14.

When an unknown integer has row indices of (1,1) and a column index of 1, the column index of the negative integer with the row indices of (1,1) is 0, 1 and 0 are input to the XOR gate 14, the XOR gate 14 will output 1. Since the output is 1, the unknown integer is positive. When referring to the look-up table 8, the unknown integer having row indices of (1,1) and a column index of 1 is 1, which is a positive integer. This agrees with the output of the XOR gate 14.

When an unknown integer has row indices of (1,1) and a column index of 0, the column index of the negative integer with the row indices of (1,1) is 0, 0 and 0 are input to the XOR gate 14, the XOR gate 14 will output 0. Since the output is 0, the unknown integer is negative. When referring to the look-up table 8, the unknown integer having row indices of (1,1) and a column index of 0 is −14, which is a negative integer. This agrees with the output of the XOR gate 14.

When two unknown integers are each provided with row indices and a column index, the magnitude comparator 120 can be used to compare their magnitudes. First, the method 20 can be used to determine signs of two unknown integers. If the signs are different, the unknown integer with a positive sign is larger than the unknown integer with a negative sign. If the signs are the same, the unknown integer with a higher cluster index is larger. If the signs are the same and the cluster indices are also the same, the unknown integer with a higher entry position, that is, a higher row index rᵢ₋₁ is larger. If the signs are the same, the cluster indices are the same, and the entry positions are also the same, the two unknown integers are equal.

From the look-up table 8, a cluster index table can be illustrated as follows:

| | | r [symbol] (r [symbol] ) | | | | |
|---|---|---|---|---|---|---|
| | | 0 | 1 | 2 | 3 | 4 |
| rᵢ₋₁ (r₁) | 0 | 1 | 3 | 5 | 2 | 4 |
| | 1 | 4 | 1 | 3 | 5 | 2 |
| | 2 | 2 | 4 | 1 | 3 | 5 |

[symbol]

indicates data missing or illegible when filed

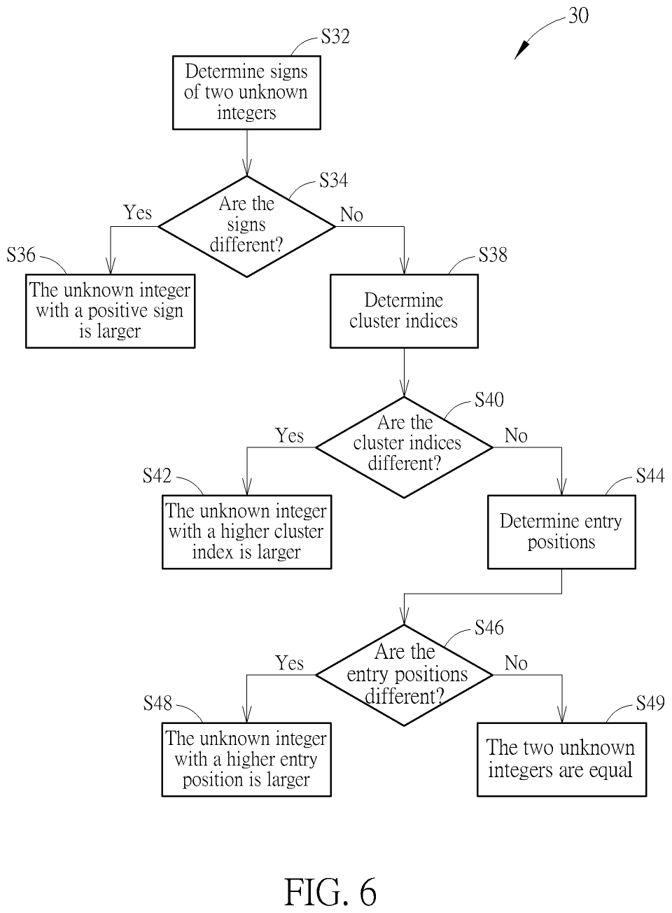

FIG. 6 is a first method 30 of magnitude comparison of two unknown integers according to an embodiment of the present invention. The method 30 comprises the following steps:

Step S32: determine signs of two unknown integers;

Step S34: check if the signs are different; if so, go to Step S36, else go to Step S38;

Step S36: the unknown integer with a positive sign is larger.

Step S38: determine the cluster indices of the two unknown integers;

Step S40: check if the cluster indices of the two unknown integers are different; if so, go to Step S42, else go to Step S44;

Step S42: the unknown integer with a higher cluster index is larger.

Step S44: determine entry positions rᵢ₋₁ of the unknown integers;

Step S46: check if the entry positions of the two unknown integers are different; if so, go to Step S48, else go to Step S49;

Step S48: the unknown integer with a higher entry position is larger.

Step S49: the two unknown integers are equal.

In Step S38, according to the look-up table 8, if the first unknown integer has row indices of (2,2), its cluster index would be 1. If the second unknown integer has row indices of (2,1), its cluster index would be 4, thus regardless of whether the two unknown integers are both positive or both negative, Step S42 can determine that the second unknown integer is larger than the first unknown integer.

In Step S44, according to the look-up table 8, if the first unknown integer has row indices of (2,2), its cluster index would be 1. If the second unknown integer has row indices of (1,1), its cluster index would also be 1, since the entry position of the first unknown integer is higher than the second unknown integer, that is, the row index rᵢ₋₁ of the first unknown integer which is 2 is larger than the row index rᵢ₋₁ of the second unknown integer which is 1, regardless of whether the two unknown integers are both positive or both negative. Step S48 can determine that the first unknown integer is larger than the second unknown integer.

In another method to compare magnitudes of two unknown integers, like the first method 30, the method 20 can be used to determine signs of the unknown integers. If the signs are different, the unknown integer with a positive sign is larger than the unknown integer with a negative sign. If the signs are the same, the unknown integers can be subtracted with each other, then the method 20 can be applied again on the difference to determine the sign of the difference. If the difference is a positive integer, then the minuend is larger.

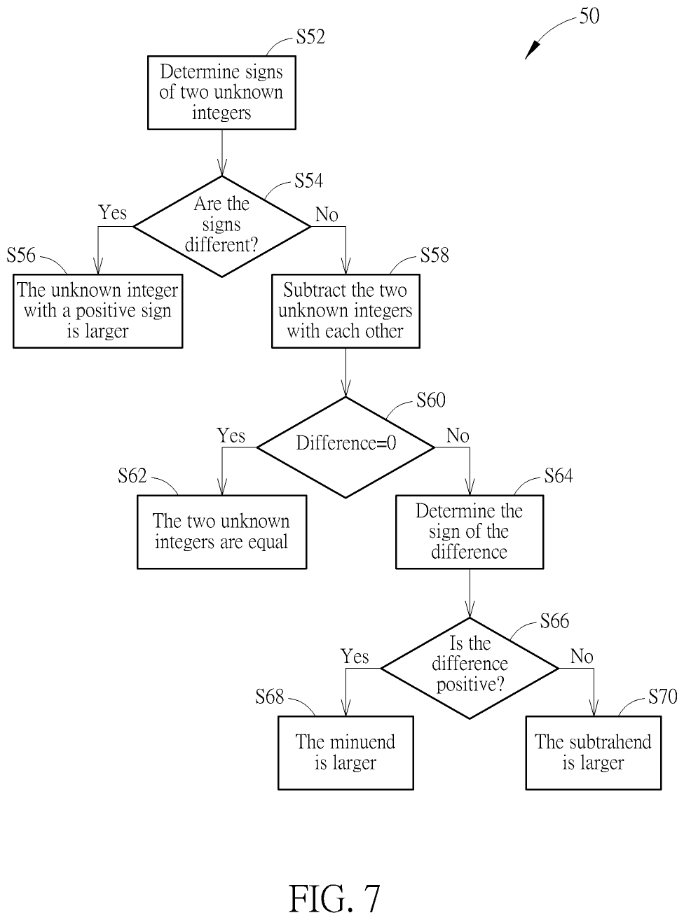

FIG. 7 is a second method 50 of magnitude comparison of two unknown integers according to an embodiment of the present invention. The method 50 comprises the following steps:

Step S52: determine signs of two unknown integers;

Step S54: check if the signs are different; if so, go to Step S56, else go to Step S58;

Step S56: the unknown integer with a positive sign is larger.

Step S58: subtract the two unknown integers with each other;

Step S60: check if the difference of the two unknown integers is 0; if so, go to Step S62, else go to Step S64;

Step S62: the two unknown integers are equal.

Step S64: determine the sign of the difference of the two unknown integers;

Step S66: check if the difference of the two unknown integers is positive; if so, go to Step S68, else go to Step S70;

Step S68: the minuend is larger.

Step S70: the subtrahend is larger.

The magnitude comparison can be done using the subtraction approach. Suppose the first unknown integer has row indices of (2,2) and a column index of 0, and is thus represented as (2,0,2), the second unknown integer has row indices of (2,1) and a column index of 1, and is thus represented as (2,1,1), and Step S54 determines that their signs are the same since both are positive, then Step S58 would subtract the first unknown integer (2,0,2) by the second unknown integer (2,1,1) to obtain (0,1,1). In Step S60, since the difference of the two unknown integers is not 0, Step S64 is performed to determine the sign of the difference of the two unknown integers. By applying the method 20 in Step S66, it can be seen that the difference of the two unknown integers is negative, thus Step S70 can determine that the subtrahend is larger. By verifying with the look-up table 8, the integer represented as (2,0,2) is 2, the integer represented as (2,1,1) is 11, and the integer represented as (0,1,1) is −9. Thus the subtrahend 11 is indeed larger than the minuend 2.

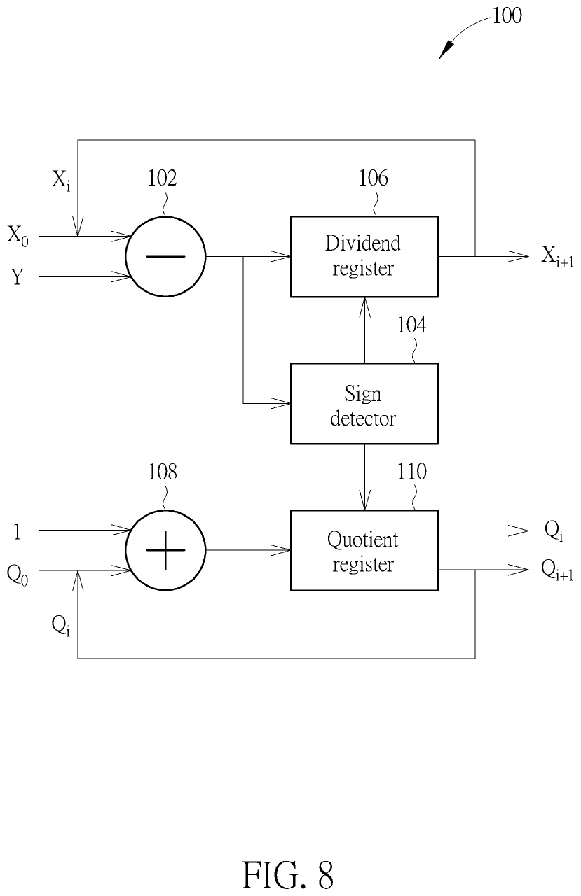

The k-RNS 2 can also perform iterative subtraction to implement division of two unknown integers if the two unknown integers have the same sign. The division is to look for quotient Q and remainder R of dividend X and divisor Y. Let initial dividend X₀=Xᵢ initial quotient Q₀=0, and iterative subtraction X′=Xᵢ−Y. FIG. 8 shows the division device 100 of the processor 4 when two unknown integers have the same sign according to an embodiment of the present invention. The division device 100 may comprise a subtractor 102, a sign detector 104, a dividend register 106, an adder 108 and a quotient register 110. The subtractor 102 has a first input for receiving the dividend Xᵢ, a second input for receiving the divisor Y, and an output for outputting the difference between the dividend Xᵢ and the divisor Y. The sign detector 104 has an input coupled to the output of the subtractor 102 for receiving the difference between the dividend Xᵢ and the divisor Y, a first output, and a second output. The dividend register 106 has a first input coupled to the output of the subtractor 102 for receiving the difference between the dividend Xᵢ and the divisor Y, a second input coupled to the first output of the sign detector 104 for receiving the sign of the difference between the dividend Xᵢ and the divisor Y, and an output coupled to the first input of the subtractor 102. If the difference is a non-zero positive integer, the dividend register 106 will output the difference as an updated dividend Xᵢ₊₁ to the first input of the subtractor 102. The adder 108 has a first input for receiving 1, a second input for receiving a quotient Qᵢ, and an output. The quotient register 110 has a first input coupled to the output of the adder 108 for receiving the sum of 1 and the quotient Qᵢ as an updated quotient Qᵢ₊₁, a second input coupled to the second output of the sign detector 104 for receiving the sign of the difference between the dividend Xᵢ and the divisor Y, a first output coupled to the second input of the adder 108 for outputting the updated quotient Qᵢ₊₁ if the sign of the difference between the dividend Xᵢ and the divisor Y is positive, and a second output for outputting the quotient Qᵢ if the sign of the difference between the dividend Xᵢ and the divisor Y is negative.

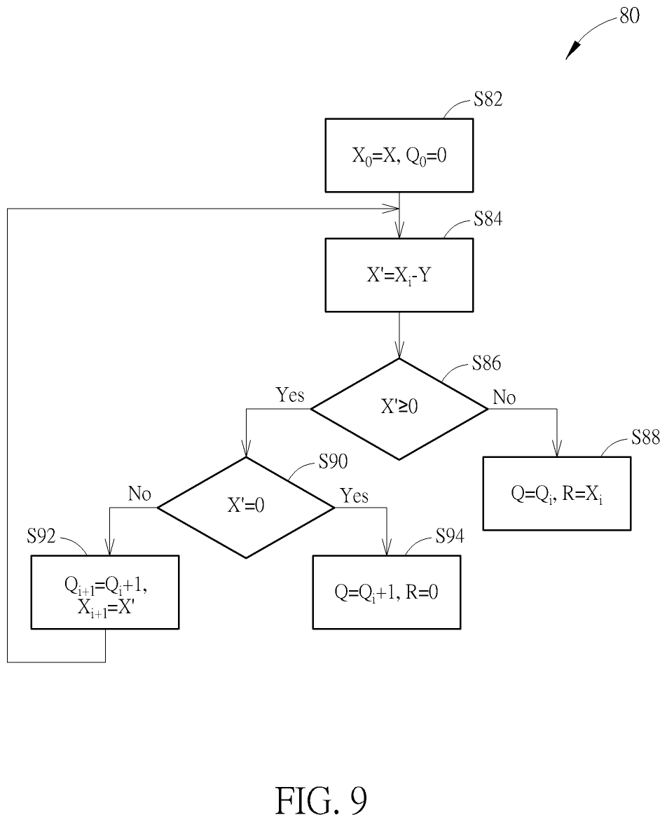

FIG. 9 is a method 80 for performing division of two unknown integers X and Y with the division device 100 of the processor 4. The method 80 comprises the following steps:

Step S82: X₀=X, Q₀=0;

Step S84: X′=Xᵢ−Y;

Step S86: check if X′≥0; if so, go to Step S90, else go to step S88;

Step S88: Q=Qᵢ, R=Xᵢ.

Step S90: check if X′=0; if so, go to Step S94, else go to step S92;

Step S92: Qᵢ₊₁=Qᵢ+1, Xᵢ₊₁=X′, go to Step S84;

Step S94: Q=Qᵢ+1, R=0.

If the two unknown integers X and Y are determined to be positive integers, the method 80 can be performed directly. If the two unknown integers X and Y are determined to be negative integers, the complement converter 150 can be used to generate the complements of the two unknown integers X and Y, then the complements of the two unknown integers X and Y can be used to perform the method 80.

An example, supposing X=14 represented as (2,0,4), and Y=3 represented as (0,1,3), can be illustrated as follows: In Step S82, X₀=(2,0,4), Q₀=0, represented as (0,0,0). In Step S84, X′=X₀−Y=(2,0,4)−(0,1,3)=(2,1,1) since the modular set is (3,2,5). In Step S86, the method 20 can determine (2,1,1) to be positive. In Step S90, (2,1,1) is not (0,0,0), Step S92 can determine) Q₁=Q₀+1=(0,0,0)+(1,1,1)=(1,1,1), and X₁=(2,1,1).

Then Step S84 is again performed. In Step S84, X′=X₁−Y=(2,1,1)−(0,1,3)=(2,0,3). In Step S86, the method 20 can determine (2,0,3) to be positive. In Step S90, (2,0,3) is not (0,0,0), Step S92 can determine Q₂=Q₁+1=(1,1,1)+(1,1,1)=(2,0,2), X₂=(2,0,3).

Then Step S84 is again performed. In Step S84, X′=X₂−Y=(2,0,3)−(0,1,3)=(2,1,0). In Step S86, the method 20 can determine (2,1,0) to be positive. In Step S90, (2,1,0) is not (0,0,0), Step S92 can determine Q₃=Q₂+1=(2,0,2)+(1,1,1)=(0,1,3), X₃=(2,1,0).

Then Step S84 is again performed. In Step S84, X′=X₃−Y=(2,1,0)−(0,1,3)=(2,0,2). In Step S86, the method 20 can determine (2,0,2) to be positive. In Step S90, (2,0,2) is not (0,0,0), Step S92 can determine Q₄=Q₃+1=(0,1,3)+(1,1,1)=(1,0,4), X₄=(2,0,2).

Then Step S84 is again performed. In Step S84, X′=X₄−Y=(2, 0,2)−(0,1,3)=(2,1,4). In Step S86, the method 20 can determine (2,1,4) to be negative. In Step S88, Q=Q₄=(1,0,4) which in decimal is 4, R=X₄=(2,0,2) which in decimal is 2. This result agrees with the decimal result of 14 divided by 3.

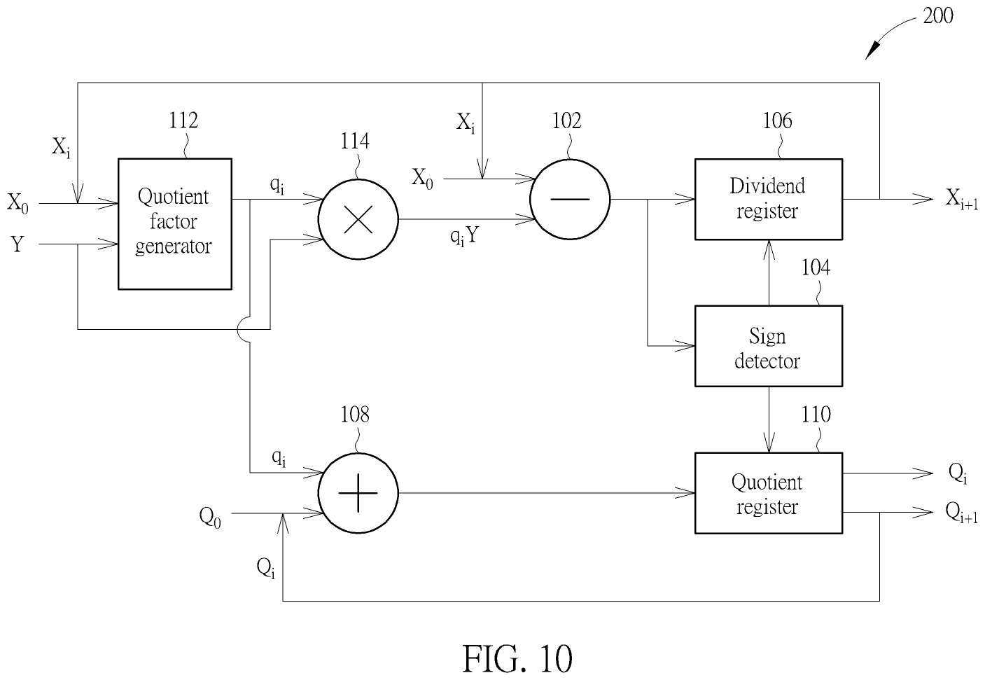

The k-RNS can also perform another iterative subtraction to implement division when two unknown integers have the same sign. The division is also to look for quotient Q and remainder R of dividend X and divisor Y. Let initial dividend X₀=Xᵢ initial quotient Q₀=0, and iterative subtraction X′=Xᵢ-qᵢY. FIG. 10 shows another division device 200 of the processor 4 when two unknown integers have the same sign. The division device 200 may comprise a subtractor 102, a sign detector 104, a dividend register 106, an adder 108, a quotient register 110, a quotient factor generator 112, and a multiplier 114. The quotient factor generator 112 has a first input for receiving the dividend Xᵢ, a second input for receiving the divisor Y, and an output for outputting the quotient factor qᵢ according to the cluster index of the dividend Xᵢ and the cluster index of the divisor Y. The quotient factor generator 112 may use a quotient factor look-up table A to generate the quotient factor qᵢ by referring to the cluster index of the dividend Xᵢ and the cluster index of the divisor Y.

Quotient Factor Look-up Table A:

| | | Cluster Index of | | | | |
|---|---|---|---|---|---|---|
| | | Dividend Xᵢ | | | | |
| | | 1 | 2 | 3 | 4 | 5 |
| Cluster | 1 | 1 | 1 | 3 | 4 | 6 |
| Index | 2 | 1 | 1 | 1 | 1 | 2 |
| Divisor | 3 | 1 | 1 | 1 | 1 | 1 |
| Y | 4 | 1 | 1 | 1 | 1 | 1 |
| | 5 | 1 | 1 | 1 | 1 | 1 |

The multiplier 114 has a first input coupled to the output of the quotient factor generator 112 for receiving the quotient factor qᵢ, a second input for receiving the divisor Y, and an output for outputting the product of the quotient factor qᵢ and the divisor Y. The subtractor 102 has a first input for receiving the dividend Xᵢ, a second input for receiving the product of the quotient factor qᵢ and the divisor Y, and an output for outputting the difference between the dividend Xᵢ, and the product of the quotient factor qᵢ and the divisor Y. The sign detector 104 has an input coupled to the output of the subtractor 102 for receiving the difference between the dividend Xᵢ, and the product of the quotient factor qᵢ and the divisor Y, a first output, and a second output. The dividend register 106 has a first input coupled to the output of the subtractor 102 for receiving the difference between the dividend Xᵢ and the product qᵢY, a second input coupled to the first output of the sign detector 104 for receiving the sign of the difference between the dividend Xᵢ and the product qᵢY, and an output coupled to the first input of the quotient factor generator 112 and the first input of the subtractor 102. If the difference is a non-zero positive integer, the dividend register 106 will output the difference as an updated dividend Xᵢ₊₁ to the first input of the quotient factor generator 112 and the first input of the subtractor 102. The adder 108 has a first input coupled to the output of the quotient factor generator 112 for receiving the quotient factor qᵢ, a second input for receiving a quotient Qᵢ, and an output for outputting the sum of the quotient factor qᵢ and the quotient Qᵢ. The quotient register 110 has a first input coupled to the output of the adder 108 for receiving the sum of the quotient factor qᵢ and the quotient Qᵢ as an updated quotient Qᵢ₊₁, a second input coupled to the second output of the sign detector 104 for receiving the sign of the difference between the dividend Xᵢ and the product qᵢY, a first output coupled to the second input of the adder 108 for outputting the updated quotient Qᵢ₊₁ if the sign of the difference between the dividend Xᵢ and the product qᵢY is positive, and a second output for outputting the quotient Qᵢ if the sign of the difference between the dividend Xᵢ and the divisor Y is negative. Compared to the division device 100, the division device 200 uses the quotient factor generator 112 to speed up the division process.

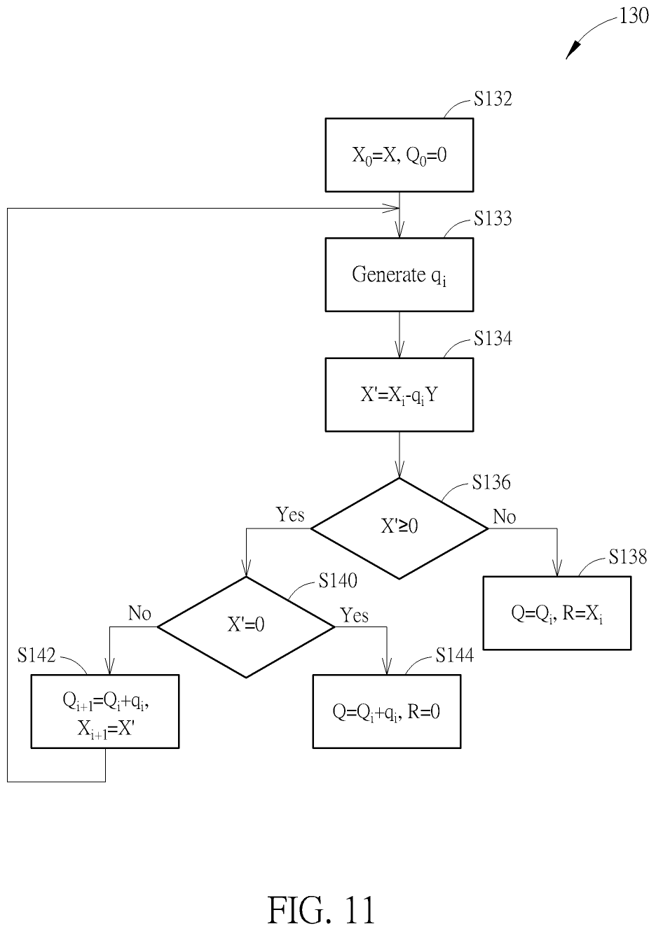

FIG. 11 is a method 130 for performing division of two unknown integers X and Y with the division device 200 of the processor 4. The method 130 comprises the following steps:

Step S132: X₀=X, Q₀=0;

Step S133: generate qi based on the cluster index of Xᵢ and the cluster index of Y using the quotient factor look-up table A;

Step S134: X′=Xᵢ−qᵢY;

Step S136: check if X′≥0; if so, go to Step S140, else go to step S138;

Step S138: Q=Qᵢ, R=Xᵢ.

Step S140: check if X′=0; if so, go to Step S144, else go to step S142;

Step S142: Qᵢ₊₁=Qᵢ+qᵢ, Xᵢ₊₁=X′, go to Step S133;

Step S144: Q=Qᵢ+qᵢ, R=0.

If the two unknown integers X and Y are determined to be positive integers, the method 130 can be performed directly. If the two unknown integers X and Y are determined to be negative integers, the complement converter 150 can be used to generate the complements of the two unknown integers X and Y, then the complements of the two unknown integers X and Y can be used to perform the method 130.

An example supposing X=14 represented as (2,0,4) and Y=2 represented as (2,0,2) can be illustrated as follows: In Step S132, X₀=(2,0,4), Q₀ represents as (0,0,0). In Step 133, the cluster index of (2,0,4) is 5, and the cluster index of (2,0,2) is 1, since the smallest positive integer in the cluster index of 5 is 12, the largest positive integer in the cluster index of 1 is 2, q₀ is set to 6 which is the quotient of 12 and 2, and represented as (0,0,1). That is, the quotient factor qᵢ is the quotient of the smallest positive integer in the cluster index of Xᵢ and the largest positive integer in the cluster index of Y when the cluster index of Xᵢ is larger than the cluster index of Y, otherwise the quotient factor qᵢ is equal to 1. And the quotient factor qᵢ can be determined by the cluster index of Xᵢ and the cluster index of Y using the quotient factor look-up table A. In Step S134, X′=X₀−q₀Y=(2,0,4)−(0,0,1)×(2,0,2)=(2,0,2). In Step S136, the method 20 can determine (2,0,2) to be positive. In Step S140, (2,0,2) is not equal to 0. Step S142 can determine Q₁=Q₀+q₀=(0,0,0)+(0,0,1)=(0,0,1), and X₁=(2,0,2).

Step S133 is again performed. In Step S133, the cluster index of (2,0,2) is 1, thus q₁ is set to (1,1,1). In Step S134, X′=X₁−q₁Y=(2,0,2)−(2,0,2)=(0,0,0). In Step S136, the method 20 can determine (0,0,0) to be 0. In Step S140, (0,0,0) is equal to 0, thus Step S144 is performed to determine Q=(0,0,1)+(1,1,1)=(1,1,2) and R=0. From the look-up table 8, (1,1,2) is the representation of the integer 7. Thus the quotient is 7, and the remainder is 0. The result agrees with the decimal result of 14 divided by 2.

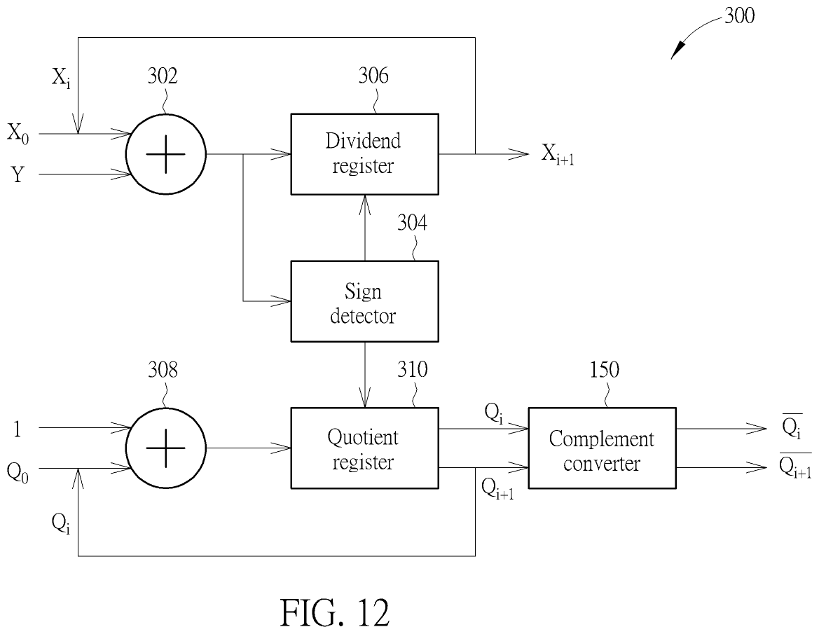

The k-RNS 2 can also perform iterative addition to implement division of two unknown integers if the two unknown integers have different signs. The division is to look for quotient Q and remainder R of a negative dividend X and a positive divisor Y. Let initial dividend X₀=Xᵢ initial quotient Q₀=0, and iterative addition X′=Xᵢ+Y. FIG. 12 shows a division device 300 of the processor 4 when two unknown integers have different signs according to an embodiment of the present invention. The division device 100 may comprise a first adder 302, a sign detector 304, a dividend register 306, a second adder 308 and a quotient register 310. The first adder 302 has a first input for receiving the dividend Xᵢ, a second input for receiving the divisor Y, and an output for outputting the sum of the dividend Xᵢ and the divisor Y. The sign detector 304 has an input coupled to the output of the first adder 302 for receiving the sum of the dividend Xᵢ and the divisor Y, a first output, and a second output. The dividend register 306 has a first input coupled to the output of the first adder 302 for receiving the sum of the dividend Xᵢ and the divisor Y, a second input coupled to the first output of the sign detector 304 for receiving the sign of the sum of the dividend Xᵢ and the divisor Y, and an output coupled to the first input of the first adder 302. If the sum is a negative integer, the dividend register 306 will output the sum as an updated dividend Xᵢ₊₁ to the first input of the first adder 302. The second adder 308 has a first input for receiving 1, a second input for receiving a quotient Qᵢ, and an output. The quotient register 310 has a first input coupled to the output of the second adder 308 for receiving the sum of 1 and the quotient Qᵢ as an updated quotient Qᵢ₊₁, a second input coupled to the second output of the sign detector 304 for receiving the sign of the sum of the dividend Xᵢ and the divisor Y, a first output coupled to the complement converter 150 so that the complement converter 150 can generate the complement of the updated quotient Qᵢ₊₁ if the sum of the dividend Xᵢ and the divisor Y is zero, and coupled to the second input of the second adder 308 for outputting the updated quotient Qᵢ₊₁ if the sign of the sum of the dividend Xᵢ and the divisor Y is negative, and a second output coupled to the complement converter 150 so that the complement converter 150 can generate the complement of the quotient Qᵢ if the sum of the dividend Xᵢ and the divisor Y is a non-zero positive integer.

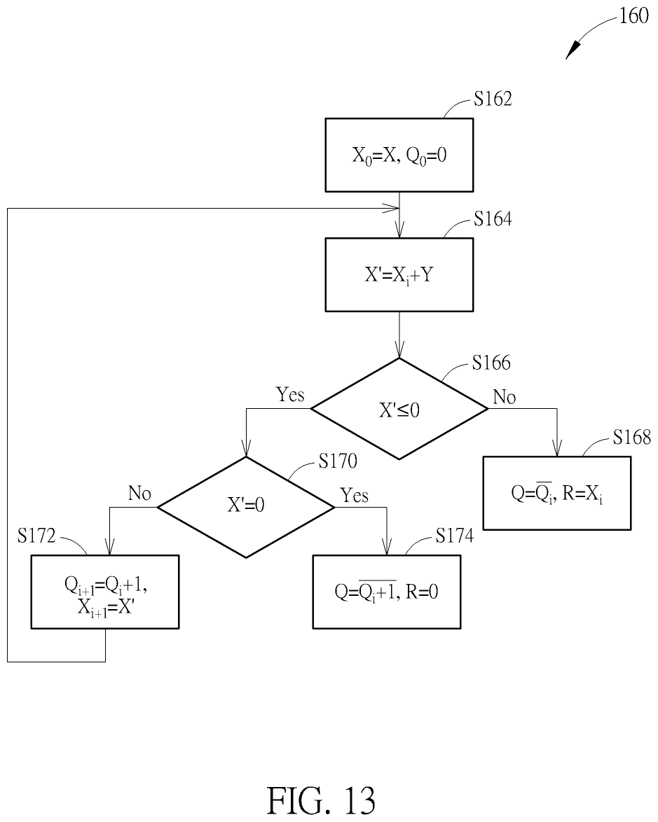

FIG. 13 is another method 160 for performing division of two unknown integers X and Y with the division device 300. The method 160 comprises the following steps:

Step S162: X₀=X, Q₀=0;

Step S164: X′=Xᵢ+Y;

Step S166: check if X′≤0; if so, go to Step S170, else go to step S168;

Step S168: Q=complement of Qᵢ, R=Xᵢ.

Step S170: check if X′=0; if so, go to Step S174, else go to step S172;

Step S172: Qᵢ₊₁=Qᵢ+1, Xᵢ₊₁=X′, go to Step S164;

Step S174: Q=complement of (Qᵢ+1), R=0.

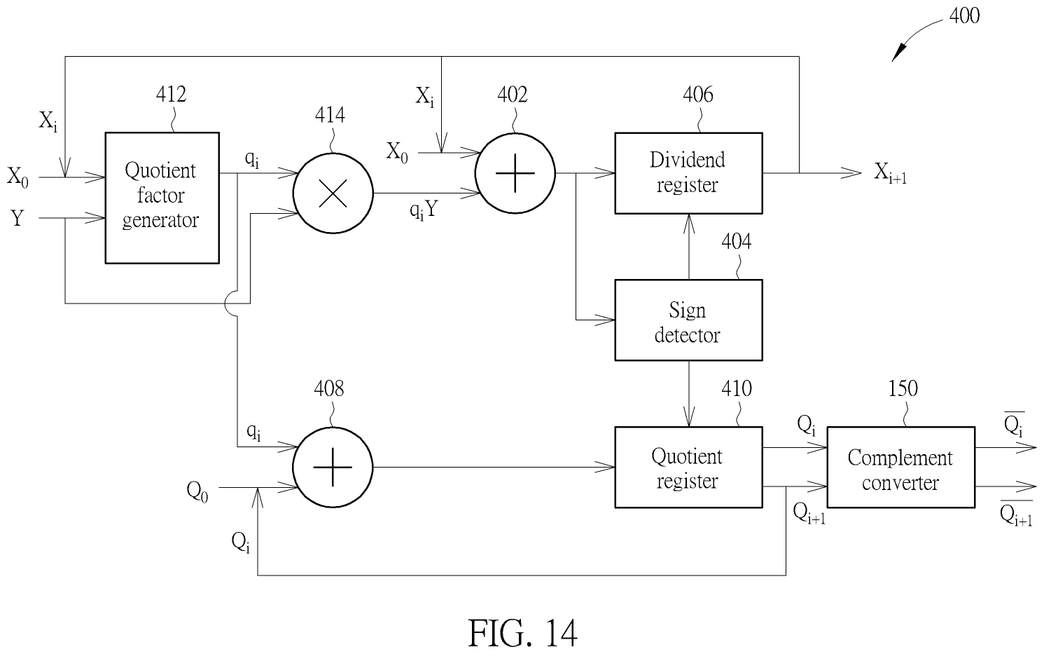

The k-RNS can also perform another iterative addition to implement division when two unknown integers have different signs. The division is also to look for quotient Q and remainder R of a negative dividend X and a positive divisor Y. Let initial dividend X₀=Xᵢ initial quotient Q₀=0, and iterative addition X′=Xᵢ+qᵢY. FIG. 14 shows another division device 400 of the processor 4 when two unknown integers have different signs. The division device 400 may comprise a first adder 402, a sign detector 404, a dividend register 406, a second adder 408, a quotient register 410, a quotient factor generator 412, and a multiplier 414. The quotient factor generator 412 has a first input for receiving the dividend Xᵢ, a second input for receiving the divisor Y, and an output for outputting the quotient factor qᵢ according to the cluster index of the dividend Xᵢ and the cluster index of the divisor Y. The quotient factor generator 412 may use a quotient factor look-up table B to generate the quotient factor qᵢ by referring to the cluster index of the dividend Xᵢ and the cluster index of the divisor Y.

Quotient Factor Look-up Table B:

| | | Cluster Index of | | | | |
|---|---|---|---|---|---|---|
| | | Dividend Xᵢ | | | | |
| | | 5 | 4 | 3 | 2 | 1 |
| Cluster | 1 | 1 | 1 | 3 | 4 | 6 |
| Index | 2 | 1 | 1 | 1 | 1 | 2 |
| of | 3 | 1 | 1 | 1 | 1 | 1 |
| Divisor | 4 | 1 | 1 | 1 | 1 | 1 |
| Y | 5 | 1 | 1 | 1 | 1 | 1 |

The multiplier 414 has a first input coupled to the output of the quotient factor generator 412 for receiving the quotient factor qᵢ, a second input for receiving the divisor Y, and an output for outputting the product of the quotient factor qᵢ and the divisor Y. The first adder 402 has a first input for receiving the dividend Xᵢ, a second input for receiving the product of the quotient factor qᵢ and the divisor Y, and an output for outputting the sum of the dividend Xᵢ, and the product of the quotient factor qᵢ and the divisor Y. The sign detector 404 has an input coupled to the output of the first adder 402 for receiving the sum of the dividend Xᵢ, and the product of the quotient factor qᵢ and the divisor Y, a first output, and a second output. The dividend register 406 has a first input coupled to the output of the first adder 402 for receiving the sum of the dividend Xᵢ and the product qᵢY, a second input coupled to the first output of the sign detector 404 for receiving the sign of the sum of the dividend Xᵢ and the product qᵢY, and an output coupled to the first input of the quotient factor generator 412 and the first input of the first adder 402. If the sum is a negative integer, the dividend register 406 will output the sum as an updated dividend Xᵢ₊₁ to the first input of the quotient factor generator 412 and the first input of the first adder 402. The second adder 408 has a first input coupled to the output of the quotient factor generator 412 for receiving the quotient factor qᵢ, a second input for receiving a quotient Qᵢ, and an output for outputting the sum of the quotient factor qᵢ and the quotient Qᵢ. The quotient register 410 has a first input coupled to the output of the second adder 408 for receiving the sum of the quotient factor qᵢ and the quotient Qᵢ as an updated quotient Qᵢ₊₁, a second input coupled to the second output of the sign detector 404 for receiving the sign of the sum of the dividend Xᵢ and the product qᵢY, a first output coupled to the second input of the second adder 408 for outputting the updated quotient Qᵢ₊₁ if the sign of the sum of the dividend Xᵢ and the product qᵢY is negative, and coupled to the complement converter 150 so that the complement converter 150 can generate the complement of the updated quotient Qᵢ₊₁ if the sum of the dividend Xᵢ and the product qᵢY is zero, and a second output coupled to the complement converter 150 so that the complement converter 150 can generate the complement of the quotient Qᵢ if the sum of the dividend Xᵢ and the product qᵢY is a non-zero positive integer. Compared to the division device 300, the division device 400 uses the quotient factor generator 412 to speed up the division process.

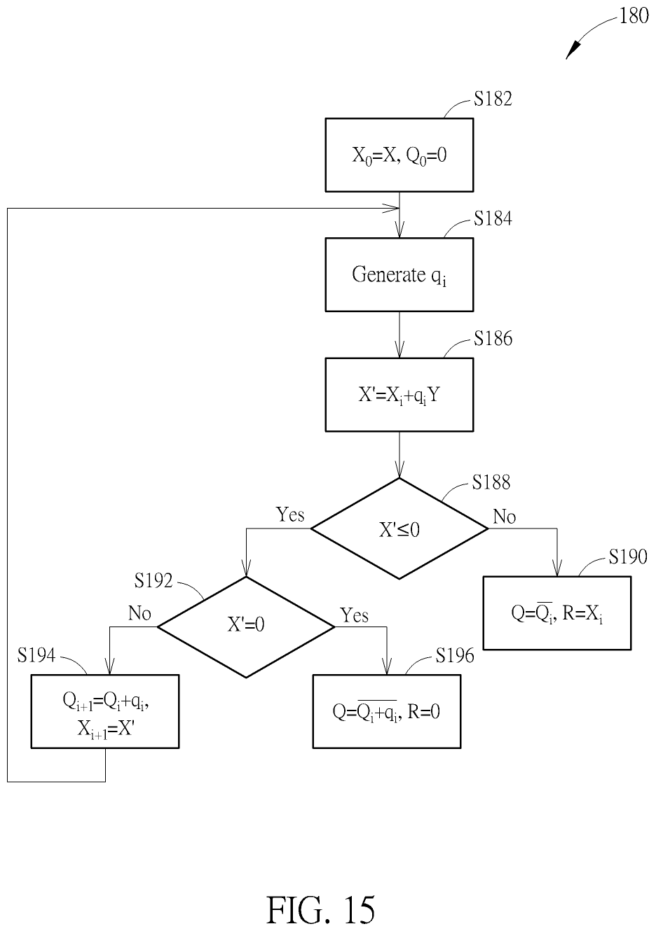

FIG. 15 is another method 180 for performing division of two unknown integers X and Y with the division device 400. The method 180 comprises the following steps:

Step S182: X₀=X, Q₀=0;

Step S184: generate qᵢ based on the cluster index of Xᵢ and the cluster index of Y using the quotient factor look-up table B;

Step S186: X′=Xᵢ+qᵢY;

Step S188: check if X′≤0; if so, go to Step S192, else go to step S190;

Step S190: Q=complement of Qᵢ, R=Xᵢ.

Step S192: check if X′=0; if so, go to Step S196, else go to step S194;

Step S194: Qᵢ₊₁=Qᵢ+qᵢ, Xᵢ₊₁=X′, go to Step S184;

Step S196: Q=complement of (Qᵢ+qᵢ), R=0.

In the method 160, 180, if the dividend X is determined to be a negative integer, and the divisor Y is determined to be a positive integer, the method 160, 180 can be performed directly. If the dividend X is determined to be a positive integer, and the divisor Y is determined to be a negative integer, the complement converter 150 can be used to generate the complements of the two unknown integers X and Y, then the complements of the two unknown integers X and Y can be used to perform the method 160, 180.

In the k-cluster residue number system 2, since the modular set is composed of coprime integers, and each integer is represented by row indices and a column index, the memory space used to store the look-up table 8 in the memory 6 is minimized. Since 2 is among the coprime integers and is used as a basis for column indices, complement conversion and sign detection can be easily performed. Since the processor 4 can perform complement conversion, sign detection, magnitude comparison and division in residue numbers, the k-cluster residue number system 2 greatly reduces the amount of calculations and improves the performance of the processor 4. Once calculations are performed, row indices and a column index of an integer can be easily used to retrieve the integer in the dynamic range. The look-up table 8 can be extended to RNS/binary conversion without using Chinese Remainder Theorem (CRT) or Mixed Radix Conversion (MRC). Therefore, the k-cluster residue number system 2 can enhance the performance of edge artificial intelligence (AI) computing. The k-cluster residue number system 2 can also be applied to other signal processing applications.

Those skilled in the art will readily observe that numerous modifications and alterations of the device and method may be made while retaining the teachings of the invention. Accordingly, the above disclosure should be construed as limited only by the metes and bounds of the appended claims.

1: A method for generating a k-cluster residue number system comprising:
generating a modular set composed of p coprime integers, the p coprime integers including 2;
generating a dynamic range by taking a product of the p coprime integers;
generating row indices for all integers in the dynamic range; and
generating column indices for all integers in the dynamic range.

2: The method of claim 1 wherein generating the row indices for all integers in the dynamic range comprises performing a following equation:
rᵢ=I mod mₖ
where:
rᵢ is a row index of the row indices;
I is an integer in the dynamic range; and
mₖ is a coprime integer of the modular set.

3: The method of claim 2 wherein generating the column indices for all integers in the dynamic range comprises performing a following equation:
rⱼ=I mod 2;
where:
rⱼ is a column index of the column indices.

4: The method of claim 3 further comprising:
subtracting p−1 coprime integers of the modular set by their corresponding row indices of an unknown integer while keeping the column index of the unknown integer intact to generate a complement of the unknown integer.

5: The method of claim 3 further comprising:
checking a column index of a negative integer corresponding to row indices of an unknown integer;
inputting a column index of the unknown integer to a first input of an XOR gate, and inputting the column index of the negative integer corresponding to the row indices of the unknown integer to a second input of the XOR gate to generate an output; and
determining a sign of the unknown integer according to the output.

6: The method of claim 3 further comprising:
determining signs of two unknown integers; and
determining an unknown integer of the two unknown integers with a positive sign is larger if the signs are different.

7: The method of claim 3 further comprising:
determining signs of two unknown integers;
determining cluster indices of the two unknown integers if the signs are identical; and
determining an unknown integer of the two unknown integers with a higher cluster index is larger if the cluster indices of the two unknown integers are different.

8: The method of claim 3 further comprising:
determining signs of two unknown integers;
determining cluster indices of the two unknown integers if the signs are identical;
determining entry positions of the two unknown integers if the cluster indices of the two unknown integers are identical; and
determining the two unknown integers are equal if the entry positions of the two unknown integers are identical.

9: The method of claim 3 further comprising:
determining signs of two unknown integers;
determining cluster indices of the two unknown integers if the signs are identical;
determining entry positions of the two unknown integers if the cluster indices of the two unknown integers are identical; and
determining an unknown integer of the two unknown integers with a higher entry position is larger.

10: The method of claim 3 further comprising:
determining signs of two unknown integers;
subtracting the two unknown integers with each other if the signs are identical;
determining the two unknown integers are equal if the difference of the two unknown integers is 0.

11: The method of claim 3 further comprising:
determining signs of two unknown integers;
subtracting the two unknown integers with each other if the signs are identical;
determining a minuend of the two unknown integers is larger than a subtrahend of the two unknown integers if a difference of the two unknown integers is a positive number.

12: The method of claim 3 further comprising:
determining signs of two unknown integers;
subtracting the two unknown integers with each other if the signs are identical;
determining a subtrahend of the two unknown integers is larger than a minuend of the two unknown integers if a difference of the two unknown integers is a negative number.

13: The method of claim 3 further comprising:
performing iterative subtraction or iterative addition to implement division.

14: The method of claim 13 wherein performing iterative subtraction or iterative addition to implement division comprises:
generating a quotient factor based on cluster indices of two unknown integers using a quotient factor look-up table.

15: The method of claim 3 further comprising:
generating a look-up table according to cluster indices, the row indices, the column indices and all integers in the dynamic set; and
storing the look-up table in a memory.

16: The method of claim 3 further comprising:
using row indices and a column index of the integer to retrieve the integer in the dynamic range.

17: A k-cluster residue number system comprising:
a processor configured to:
generate a modular set composed of p coprime integers, the p coprime integers including 2;
generate a dynamic range by taking a product of the p coprime integers;
generate row indices for all integers in the dynamic range;
generate column indices for all integers in the dynamic range; and
generate a look-up table according to the row indices, the column indices and all integers in the dynamic set; and
a memory coupled to the processor and configured to store the look-up table.

18: The k-cluster residue number system of claim 17 wherein the processor comprises a complement converter configured to subtract p−1 coprime integers of the modular set by their corresponding row indices of an unknown integer while keeping a column index of the unknown integer intact to generate a complement of the unknown integer.

19: The k-cluster residue number system of claim 18 wherein the processor further comprises a division device comprising:
a first adder having a first input for receiving a dividend, a second input for receiving a divisor, and an output for outputting a sum of the dividend and the divisor;
a sign detector having an input coupled to the output of the first adder for receiving the sum of the dividend and the divisor, a first output, and a second output;
a dividend register having a first input coupled to the output of the first adder for receiving the sum of the dividend and the divisor, a second input coupled to the first output of the sign detector for receiving a sign of the sum of the dividend and the divisor, and an output coupled to the first input of the first adder for outputting the sum as an updated dividend to the first input of the first adder if the sum is a negative integer;
a second adder having a first input for receiving 1, a second input for receiving a quotient, and an output; and
a quotient register having a first input coupled to the output of the second adder for receiving the sum of 1 and the quotient as an updated quotient, a second input coupled to the second output of the sign detector for receiving the sign of the sum of the dividend and the divisor, a first output coupled to the complement converter, and coupled to the second input of the second adder for outputting the updated quotient if the sign of the sum of the dividend and the divisor is negative, and a second output coupled to the complement converter;
wherein the complement converter generates a complement of the updated quotient if the sum of the dividend and the divisor is zero, and generates a complement of the quotient if the sum of the dividend and the divisor is a non-zero positive integer.

20: The k-cluster residue number system of claim 18 wherein the processor further comprises a division device comprising:
a quotient factor generator having a first input for receiving a dividend, a second input for receiving a divisor, and an output for outputting a quotient factor according to a cluster index of the dividend and a cluster index of the divisor;
a multiplier having a first input coupled to the output of the quotient factor generator for receiving the quotient factor, a second input for receiving the divisor, and an output for outputting a product of the quotient factor and the divisor;
a first adder having a first input for receiving the dividend, a second input for receiving the product of the quotient factor and the divisor, and an output for outputting a sum of the dividend and the product of the quotient factor and the divisor;
a sign detector having an input coupled to the output of the first adder for receiving the sum of the dividend and the product of the quotient factor and the divisor, a first output, and a second output;
a dividend register having a first input coupled to the output of the first adder for receiving the sum of the dividend and the product, a second input coupled to the first output of the sign detector for receiving a sign of the sum of the dividend and the product, and an output coupled to the first input of the quotient factor generator and the first input of the first adder for outputting the sum as an updated dividend to the first input of the quotient factor generator and the first input of the first adder if the sum is a negative integer;
a second adder having a first input coupled to the output of the quotient factor generator for receiving the quotient factor, a second input for receiving a quotient, and an output for outputting a sum of the quotient factor and the quotient; and
a quotient register having a first input coupled to the output of the second adder for receiving the sum of the quotient factor and the quotient as an updated quotient, a second input coupled to the second output of the sign detector for receiving the sign of the sum of the dividend and the product, a first output coupled to the second input of the second adder for outputting the updated quotient if the sign of the sum of the dividend and the product is negative, and coupled to the complement converter, and a second output coupled to the complement converter;
wherein the complement converter generates a complement of the updated quotient if the sum of the dividend and the product is zero, and generates a complement of the quotient if the sum of the dividend and the product is a non-zero positive integer.

21: The k-cluster residue number system of claim 17 wherein the processor comprises a sign detector comprising:
a negative column index register configured to store a column index of each set of row indices when the set of row indices corresponds to a negative integer, the negative column index register having inputs for receiving a set of row indices of an unknown integer, and an output; and
an XOR gate having a first input coupled to the output of the negative column index register for receiving a column index of the unknown integer when the unknown integer is negative, a second input for receiving a column index of the unknown integer, and an output for indicating a sign of the unknown integer.

22: The k-cluster residue number system of claim 17 wherein the processor comprises a magnitude comparator configured to:
determine signs of two unknown integers; and
determine an unknown integer of the two unknown integers with a positive sign is larger if the signs are different.

23: The k-cluster residue number system of claim 17 wherein the processor comprises a magnitude comparator configured to:
determine signs of two unknown integers;
determine cluster indices of the two unknown integers if the signs are identical; and
determine an unknown integer of the two unknown integers with a higher cluster index is larger if the cluster indices of the two unknown integers are different.

24: The k-cluster residue number system of claim 17 wherein the processor comprises a magnitude comparator configured to:
determine signs of two unknown integers;
determine cluster indices of the two unknown integers if the signs are identical;
determine entry positions of the unknown integers if the cluster indices of the two unknown integers are identical; and
determine an unknown integer of the two unknown integers with a higher entry position is larger.

25: The k-cluster residue number system of claim 17 wherein the processor comprises a division device comprising:
a subtractor having a first input for receiving a dividend, a second input for receiving a divisor, and an output for outputting a difference between the dividend and the divisor;
a sign detector having an input coupled to the output of the subtractor for receiving the difference between the dividend and the divisor, a first output, and a second output;
a dividend register having a first input coupled to the output of the subtractor for receiving the difference between the dividend and the divisor, a second input coupled to the first output of the sign detector for receiving a sign of the difference between the dividend and the divisor, and an output coupled to the first input of the subtractor;
an adder having a first input for receiving 1, a second input for receiving a quotient, and an output; and
a quotient register having a first input coupled to the output of the adder for receiving a sum of 1 and the quotient as an updated quotient, a second input coupled to the second output of the sign detector for receiving the sign of the difference between the dividend and the divisor, a first output coupled to the second input of the adder for outputting the updated quotient if the sign of the difference between the dividend and the divisor is positive, and a second output for outputting the quotient if the sign of the difference between the dividend and the divisor is negative;
wherein if the difference between the dividend and the divisor is a non-zero positive integer, the dividend register will output the difference as an updated dividend to the first input of the subtractor.

26: The k-cluster residue number system of claim 17 wherein the processor comprises a division device comprising:
a quotient factor generator having a first input for receiving a dividend, a second input for receiving a divisor, and an output for outputting a quotient factor according to a cluster index of the dividend and a cluster index of the divisor;
a multiplier having a first input coupled to the output of the quotient factor generator for receiving the quotient factor, a second input for receiving the divisor, and an output for outputting a product of the quotient factor and the divisor;
a subtractor having a first input for receiving the dividend, a second input for receiving the product of the quotient factor and the divisor, and an output for outputting a difference between the dividend and the product of the quotient factor and the divisor;
a sign detector having an input coupled to the output of the subtractor for receiving the difference, a first output, and a second output;
a dividend register having a first input coupled to the output of the subtractor for receiving the difference, a second input coupled to the first output of the sign detector for receiving a sign of the difference, and an output coupled to the first input of the quotient factor generator and the first input of the subtractor;
an adder having a first input coupled to the output of the quotient factor generator for receiving the quotient factor, a second input for receiving a quotient, and an output for outputting a sum of the quotient factor and the quotient; and
a quotient register having a first input coupled to the output of the adder for receiving the sum of the quotient factor and the quotient as an updated quotient, a second input coupled to the second output of the sign detector for receiving the sign of the difference, a first output coupled to the second input of the adder for outputting the updated quotient if the sign of the difference is positive, and a second output for outputting the quotient if the sign of the difference is negative;
wherein if the difference is a non-zero positive integer, the dividend register will output the difference as an updated dividend to the first input of the quotient factor generator and the first input of the subtractor.
